(19) United States
(12) Patent Application Publication
(10) Pub. No.: US 2017/0272865 A1
(43) Pub. Date: Sep. 21, 2017

(54) VOICE COIL WIRE, VOICE COIL MANUFACTURED BY WINDING THE SAME, LOUDSPEAKER AND VIBRATION MOTOR

(71) Applicant: GOERTEK INC., Weifang (CN)

(72) Inventors: Guodong ZHAO, Weifang (CN); Chaofeng HE, Weifang (CN); Ruixiang MU, Weifang (CN)

(73) Assignee: GOERTEK INC., Weifang (CN)

(21) Appl. No.: 15/329,911

(22) PCT Filed: Dec. 7, 2015
(86) PCT No.: PCT/CN2015/096595

§ 371 Date: Jan. 27, 2017

(30) Foreign Application Priority Data
Aug. 12, 2015 (CN) 201510492589.6

(51) Int. Cl. H04R 9/04; H04R 9/02; H04R 9/06; H02K 33/18

(52) U.S. Cl. CPC H04R 9/046; H02K 33/18; H04R 9/025; H04R 9/06; H01B 1/02

(57) ABSTRACT

The present disclosure discloses a voice coil wire, a voice coil manufactured by winding the voice coil wire, a loudspeaker and a vibration motor, and relates to the technical field of electroacoustic products. The voice coil wire comprises a conductor layer having an electric conduction function, the outside of the conductor layer being wrapped by an insulating layer, wherein the conductor layer comprises a first conductor layer disposed inside and a second conductor layer wrapping the outside of the first conductor layer, and one of the first conductor layer and the second conductor layer is made of a soft magnetic material. The voice coil wire, the voice coil manufactured by winding the voice coil wire, the loudspeaker and the vibration motor of the present disclosure solve the technical problem of the prior art that voice coils do not have magnetoconductivity. The voice coil wire, the voice coil manufactured by winding the voice coil wire, and the voice coils in the loudspeaker and the vibration motor of the present disclosure have a magnetic conduction function, effectively improve the performances of the loudspeaker and the vibration motor and reduce the masses and sizes of the loudspeaker and the vibration motor.

### TECHNICAL FIELD

The present disclosure relates to the technical field of electroacoustic products, and particularly to a voice coil wire, a voice coil manufactured by winding the voice coil wire, a loudspeaker provided with the voice coil and a vibration motor with the voice coil.

### BACKGROUND

Loudspeakers and vibration motors are both important components in portable electronic devices. The loudspeaker is used to convert an acoustic wave electrical signal into sound and transmit it out, e.g., broadcast an audio signal such as a song or broadcast various prompt tones. The vibration motor converts an alternating electrical signal into a mechanical vibration and is used to prompt the user to receive various information. The loudspeaker and the vibration motor operate on substantially the same principle of introducing an alternating current into the voice coil. The voice coil is subjected to a Lorentz force action changing correspondingly in a magnetic field according to the change of the introduced alternating current, and thereby converts the electrical energy into acoustic energy or mechanical energy.

The magnetic circuit component in the loudspeaker is fixed and immobile, and the voice coil is movable. When the alternating current is introduced into the voice coil, the voice coil moves reciprocatingly according to the received Lorentz force in the magnetic field and thereby drives a vibrating diaphragm integrally fixed therewith to vibrate, and the vibrating diaphragm drives air to generate a sound. The voice coil in the vibration motor is fixed and immobile, and the magnet and the mass block are movable. According to the principle of an acting force and a reacting force, when the alternating current is introduced in the voice coil, the magnet and the mass block will generate reciprocating movement and thereby cause the portable electronic device to vibrate.

Along with the constant development of science and technology, portable electronic devices constantly develop in the tendency of light weight, slimness and high performance, so that loudspeakers and vibration motora are also constantly reduced in size and improved in performance. However, the current voice coils are mostly made of ordinary enameled wires. The voice coils made of the ordinary enameled wires only have the functions of conducting electricity and cutting magnetic fields and do not have the function of conducting magnetism, so that a few number of magnetic lines of force in the magnetic circuit pass through the voice coil, and the voice coil receives a little Lorentz force and exhibits an undesirable performance. To increase the Lorentz force received by voice coil and improve the performance, it is necessary to increase the size of the magnetic circuit, which leads to increase the sizes of loudspeakers and vibration motors, so the loudspeakers and the vibration motors cannot satisfy the development requirement for light weight and slimness.

SUMMARY OF THE DISCLOSURE

In view of the above defects, the first technical problem to be solved by the present disclosure is to provide a voice coil which has an electric conduction function as well as a magnetic conduction function.

Based on the same inventive concept, the second technical problem to be solved by the present disclosure is to provide a voice coil which has a magnetic conduction function and can increase the magnetic field intensity and reduce magnetic flux leakage.

Based on the same inventive concept, the third technical problem to be solved by the present disclosure is to provide a loudspeaker which exhibits small size and good acoustic performance.

Based on the same inventive concept, the fourth technical problem to be solved by the present disclosure is to provide a vibration motor which exhibits small size, strong vibration feeling and good use performance.

To solve the above first technical problem, the technical solution of the present disclosure is as follows:

a voice coil wire, comprising a conductor layer having an electric conduction function, and the outside of the conductor layer being wrapped by an insulating layer, wherein the conductor layer comprises a first conductor layer disposed inside and a second conductor layer wrapping the outside of the first conductor layer, and one of the first conductor layer and the second conductor layer is made of a soft magnetic material.

As an embodiment, the first conductor layer is made of the soft magnetic material, and the second conductor layer is made of copper.

As another embodiment, the first conductor layer is made of copper, and the second conductor layer is made of the soft magnetic material.

Preferably, the soft magnetic material is one of pure iron, low-carbon steel, iron-silicon alloys, iron-nickel alloys, iron-silicon-aluminum alloys, iron-aluminum alloys or iron-cobalt alloys.

Preferably, the outside of the insulating layer is wrapped by a self-adhesive layer.

To solve the above second technical problem, the technical solution of the present disclosure is as follows:

A voice coil manufactured by winding a voice coil wire, wherein the voice coil wire is the aforesaid voice coil wire.

To solve the above third technical problem, the technical solution of the present disclosure is as follows:

A loudspeaker, comprising a vibration system and a magnetic circuit system, the vibration system comprising a vibrating diaphragm and a voice coil, which are joint together, wherein the voice coil is the above-mentioned voice coil.

To solve the above fourth technical problem, the technical solution of the present disclosure is as follows:

A vibration motor, comprising a housing, inside which is fixed a voice coil, and further comprising a magnet and a mass block which are secured together, wherein the magnet and the mass block are suspended in the housing via an elastic support, and wherein the voice coil is the above-mentioned voice coil.

By employing the above technical solutions, the present disclosure achieves the following advantageous effects:

In the present disclosure, the conductor layer of the voice coil wire comprises a first conductor layer disposed inside and a second conductor layer wrapping the outside of the first conductor layer, and one of the first conductor layer and the second conductor layer is made of a soft magnetic material. The soft magnetic material has a high magnetoconductivity and is apt to be magnetized and demagnetized, and may achieve maximum magnetization intensity with a minimum external magnetic field. Hence, Based on the above advantages of the soft magnetic material, the voice coil wire containing the soft magnetic material layer of the present disclosure has an excellent magnetic conduction performance, and the voice coil formed by the winding voice coil wire may allow the magnetic lines of forces in the magnetic field to pass through the voice coil to a maximum degree, which effectively increases the magnetic induction intensity, and meanwhile effectively reduces magnetic flux leakage. Since the voice coil is formed by the winding voice coil wire, the voice coil of the present disclosure may allow the magnetic lines of forces in the magnetic field to pass through the voice coil to a maximum degree, which effectively increases the magnetic induction intensity, and meanwhile effectively reduces magnetic flux leakage, thereby obtaining the optimal performance. Since the Lorentz force received by the voice coil in the magnetic field increases, it is feasible to, while satisfying the original requirements for performance, reduce the size of the magnetic circuit to a minimum and thereby satisfy the development requirement for light weight and slimness of the loudspeaker and vibration motor.

Since the voice coil of the loudspeaker of the present disclosure is the aforesaid voice coil, the loudspeaker of the present disclosure has advantages such as small size, light weight and good acoustic performance.

Since the voice coil of the vibration motor of the present disclosure is the aforesaid voice coil, the vibration motor of the present disclosure has advantages such as small size, light weight and strong vibration feeling.

To conclude, the voice coil wire, the voice coil manufactured by winding the voice coil wire, the loudspeaker and the vibration motor of the present disclosure solve the technical problem of the prior art that voice coils do not have magnetoconductivity. The voice coil wire, the voice coil manufactured by winding the voice coil wire, and the voice coils in the loudspeaker and the vibration motor of the present disclosure have a magnetic conduction function, effectively improve the performances of the loudspeaker and the vibration motor and reduce the masses and sizes of the loudspeaker and the vibration motor.

The above depictions are only generalization of technical solutions of the present disclosure. Specific embodiments of the present disclosure are presented below to make the technical means of the present disclosure clearer.

### BRIEF DESCRIPTION OF THE DRAWINGS

The drawings are used to provide further understanding of the present disclosure, constitute part of the description, illustrate the present disclosure together with the embodiments of the present disclosure, and do not constitute limitation of the present disclosure. In the drawings:

FIG. 1 is a cross-sectional schematic view of a voice coil wire according to the present disclosure;

FIG. 2 is a simulation diagram of the Lorentz force received by a voice coil of the prior art in a magnetic field; and

FIG. 3 is a simulation diagram of the Lorentz force received by a voice coil manufactured by winding a voice coil wire of the present disclosure in a magnetic field.

in the figures, the reference number 10 denotes a first conductor layer, 20 a second conductor layer, 30 an insulating layer and 40 a self-adhesive layer.

### DETAILED DESCRIPTION

The present disclosure will be further illustrated with reference to the figures and the embodiments.

### Embodiment 1

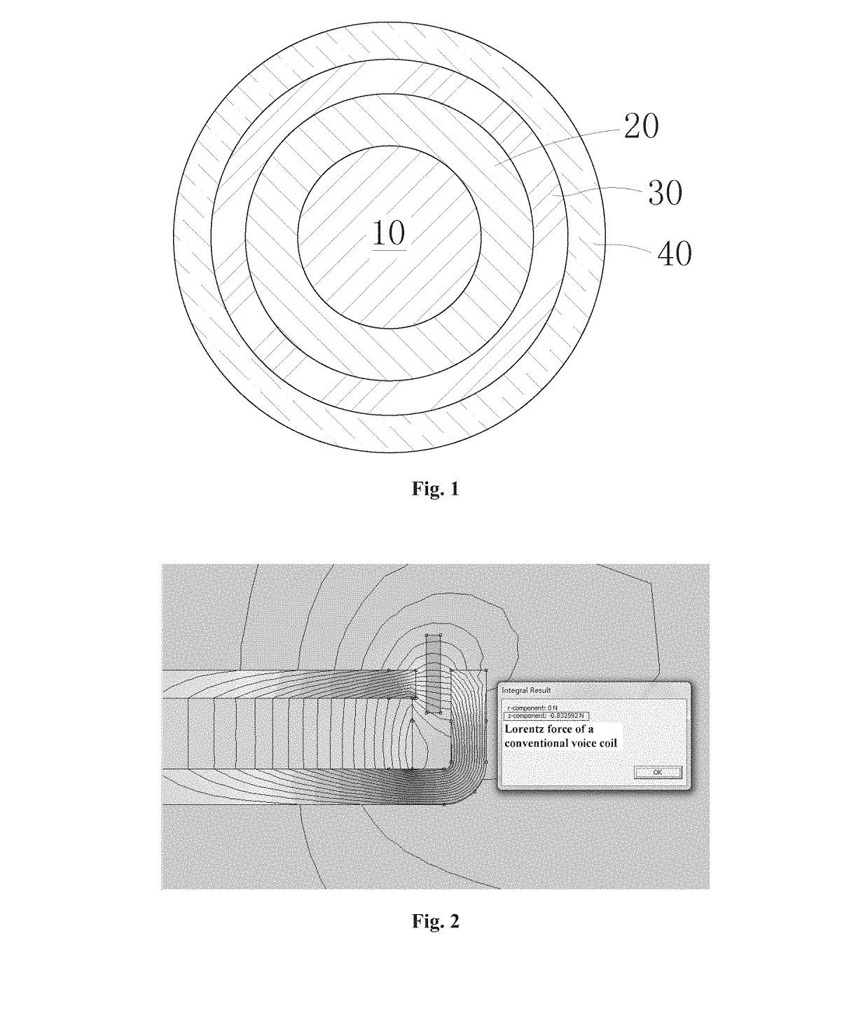

As shown in FIG. 1, a voice coil wire, comprising a conductor layer having an electric conduction function, and the outside of the conductor layer being wrapped by an insulating layer 30, and the outside of the insulating layer 30 is wrapped by a self-adhesive layer 40, wherein the conductor layer comprises a first conductor layer 10 disposed inside, and a second conductor layer 20 wrapping the outside of the first conductor layer 10.

As shown in FIG. 1, the first conductor layer 10 is made of a soft magnetic material. The soft magnetic material in the present embodiment is one of pure iron, low-carbon steel, iron-silicon alloys, iron-nickel alloys, iron-silicon-aluminum alloys, iron-aluminum alloys or iron-cobalt alloys, but not limited to the above materials. A metal is feasible so long as it has a high magnetoconductivity and an electrically conductive performance. The second conductor layer 20 is made of copper. The present disclosure adds a conductor layer made of a soft magnetic material into the voice coil wire, so that the voice coil wire adds the magnetic conduction function, such that the voice coil manufactured by winding the voice coil wire has a magnetic conduction function, which increases the Lorentz force received by the voice coil in the magnetic field, and thereby boosts the performance of products provided with the voice coil, such as a loudspeaker, a vibration motor or the like.

### Embodiment 2

As shown in FIG. 1, the present embodiment is substantially the same as Embodiment 1 and differs from Embodiment 1 in that the first conductor layer 10 is made of copper, and the second conductor layer 20 is made of a soft magnetic material.

### Embodiment 3

A voice coil manufacture by winding the voice coil wire, wherein the voice coil wire is the voice coil wire as stated in Embodiment 1 and Embodiment 2.

The voice coil may allow the magnetic lines of force in the magnetic field to pass through the voice coil to a maximum degree, which effectively increases the magnetic induction intensity, and meanwhile effectively reduces magnetic flux leakage, thereby obtaining the optimal performance.

### Embodiment 4

A loudspeaker, comprising a vibration system and a magnetic circuit system, the vibration system comprising a vibrating diaphragm and a voice coil, which are joint together, wherein the voice coil is the voice coil as stated in Embodiment 3.

The loudspeaker has advantages such as small size, light weight and good acoustic performance.

### Embodiment 5

A vibration motor, comprising a housing, inside which is fixed a voice coil, and further comprising a magnet and a mass block which are secured together, wherein the magnet and the mass block are suspended in the housing via an elastic support, wherein the magnet and the mass block correspond to the voice coil in a vertical direction, and wherein the voice coil is the voice coil stated in Embodiment 3.

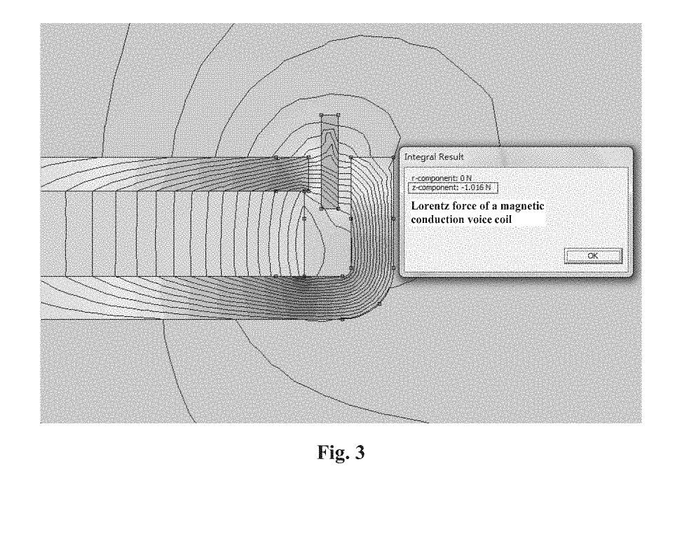

The present disclosure adds a conductor layer made of a soft magnetic material into the voice coil wire, so that the voice coil wire adds the magnetic conduction function, such that the voice coil manufactured by winding the voice coil wire has a magnetic conduction function, which increases the Lorentz force received by the voice coil in the magnetic field. Technicians carried out simulation experiments for the voice coil of the prior art and the voice coil manufactured by winding the voice coil wire of the present disclosure in terms of their force bearing in the same magnetic field. The experiment results are shown in FIG. 2 and FIG. 3. The Lorentz force received by the voice coil of the prior art is 0.832592N, and the Lorentz force received by the voice coil manufactured by winding the voice coil wire of the present disclosure is 1.016N. It can be seen that in the same magnetic field the voice coil manufactured by winding the voice coil wire of the present disclosure receives a larger Lorentz force, exhibits a better performance and thereby effectively improves the performances of the loudspeaker and the vibration motor and reduces the masses and sizes of the loudspeaker and the vibration motor.

The present disclosure is not limited to the above specific embodiments. Diverse variations made by those having ordinary skill in the art from the above concept without making any inventive efforts all fall within the protection scope of the present disclosure.

1. A voice coil wire, comprising a conductor layer having an electric conduction function, and the outside of the conductor layer being wrapped by an insulating layer, wherein the conductor layer comprises a first conductor layer disposed inside and a second conductor layer wrapping the outside of the first conductor layer, and one of the first conductor layer and the second conductor layer is made of a soft magnetic material.

2. The voice coil wire according to claim 1, wherein the first conductor layer is made of the soft magnetic material, and the second conductor layer is made of copper.

3. The voice coil wire according to claim 1, wherein the first conductor layer is made of copper, and the second conductor layer is made of the soft magnetic material.

4. The voice coil wire according to claim 2 or 3, wherein the soft magnetic material is one of pure iron, low-carbon steel, iron-silicon alloys, iron-nickel alloys, iron-silicon-aluminum alloys, iron-aluminum alloys or iron-cobalt alloys.

5. The voice coil wire according to claim 4, wherein the outside of the insulating layer is wrapped by a self-adhesive layer.

6. A voice coil manufactured by winding a voice coil wire, wherein the voice coil wire is the voice coil wire according to any one of claims 1-5.

7. A loudspeaker, comprising a vibration system and a magnetic circuit system, the vibration system comprising a vibrating diaphragm and a voice coil, which are joint together, wherein the voice coil is the voice coil according to claim 6.

8. A vibration motor, comprising a housing, inside which is fixed a voice coil, and further comprising a magnet and a mass block which are secured together, wherein the magnet and the mass block are suspended in the housing via an elastic support, wherein the magnet and the mass block correspond to the voice coil in a vertical direction, and wherein the voice coil is the voice coil according to claim 6.

1. A voice coil wire, comprising a conductor layer having an electric conduction function, and the outside of the conductor layer being wrapped by an insulating layer, wherein the conductor layer comprises a first conductor layer disposed inside and a second conductor layer wrapping the outside of the first conductor layer, and one of the first conductor layer and the second conductor layer is made of a soft magnetic material.

2. The voice coil wire according to claim 1, wherein the first conductor layer is made of the soft magnetic material, and the second conductor layer is made of copper.

3. The voice coil wire according to claim 1, wherein the first conductor layer is made of copper, and the second conductor layer is made of the soft magnetic material.

4. The voice coil wire according to claim 1, wherein the soft magnetic material is one of pure iron, low-carbon steel, iron-silicon alloys, iron-nickel alloys, iron-silicon-aluminum alloys, iron-aluminum alloys or iron-cobalt alloys.

5. The voice coil wire according to claim 1, wherein the outside of the insulating layer is wrapped by a self-adhesive layer.

6. (canceled)

7. A loudspeaker, comprising a vibration system and a magnetic circuit system, the vibration system comprising a vibrating diaphragm and a voice coil, which are joint together, wherein the voice coil is manufactured by winding a voice coil wire, and wherein the voice coil wire is the voice coil wire according to claim 1.

8. A vibration motor, comprising a housing, inside which is fixed a voice coil, and further comprising a magnet and a mass block which are secured together, wherein the magnet and the mass block are suspended in the housing via an elastic support, wherein the magnet and the mass block correspond to the voice coil in a vertical direction, and wherein the voice coil is manufactured by winding a voice coil wire, and wherein the voice coil wire is the voice coil wire according to claim 1.
